(19) United States
(12) Patent Application Publication
(10) Pub. No.: US 2021/0235678 A1
(43) Pub. Date: Aug. 5, 2021

(54) FISHING POLE HANDLE AND FISHING POLE ASSEMBLY INCLUDING SAME

(71) Applicant: Jared W. Thiele, Fort Wayne, IN (US)

(72) Inventor: Jared W. Thiele, Fort Wayne, IN (US)

(21) Appl. No.: 16/783,131

(22) Filed: Feb. 5, 2020

(51) Int. Cl. A01K 87/08; A01K 87/06

(52) U.S. Cl. CPC A01K 87/08; A01K 87/06

(57) ABSTRACT

A fishing pole handle including an elongate first portion that extends along a first axis and is configured to engage a foot of an attachable reel assembly, an elongate second portion that extends along a second axis substantially perpendicular to the first axis, the first and second portions constrained against relative movement in directions along the first axis, and a selectively engageable coupling mechanism between the first and second portions. The first and second portions are rotatably retainable to each other about the first axis through engagement of the coupling mechanism, and are relatively moveable about the first axis through disengagement of said coupling mechanism. Relative to each other about the first axis, the first and second portions are selectively moveable between alternative ones of a plurality of different radial orientations or rotatably retained to each other in one of the plurality of different radial orientations.

### BACKGROUND

### 1. Field of the Invention

The present invention generally relates to sporting equipment, particularly to fishing pole assemblies, and more particularly to fishing pole handles.

### 2. Description of the Related Art

It is known to provide fishing pole handles having an elongate first portion to which is affixed a coaxially-extending rod member and a reel assembly, and an elongate second portion that extends substantially perpendicularly from the handle first portion, for light jigging or ice fishing. In prior such fishing pole handles, the first and second portions are axially and rotatably fixed to each other, either integrally or through a clamping mechanism, whereby the radial orientation of the handle second portion about the longitudinal axis of the handle first portion, and thus the radial orientation of the handle second portion relative to the reel assembly and rod member affixed to the first portion, cannot be adjusted, either at all, or quickly and easily, and without using tools between a plurality of different radial orientations. Such limitations impair many users from adjusting their grip to one that is more comfortable, convenient, and/or ergonomically functional.

It is desirable to provide a fishing pole handle for light jigging or ice fishing that overcomes the shortcomings of prior such fishing pole handles, or fishing pole assemblies including such handles.

### SUMMARY

The present invention includes, in one form thereof, a fishing pole handle including an elongate first portion having a first axis along which the first portion extends. The first portion has a first end and a second end spaced along the first axis. The first portion is configured to engage a foot of a reel assembly attachable to the fishing pole handle at a reel assembly attachment position having a radially fixed orientation about the first axis and an axially fixed location in directions along the first axis. The fishing pole handle also includes an elongate second portion having a second axis along which the second portion extends. The second portion has a third end and a fourth end spaced along the second axis. The third end is rotatably connected to the first portion about the first axis and the second axis is substantially perpendicular to the first axis. The second portion is spaced from the first end and the second end. The fishing pole handle also includes a selectively engageable coupling mechanism between the first portion and the second portion. The first and second portions are rotatably retainable to each other about the first axis through engagement of the coupling mechanism, and are relatively moveable about the first axis through disengagement of the coupling mechanism. The first and second portions are constrained against relative movement in directions along the first axis. Relative to each other about the first axis, the first and second portions are selectively moveable between alternative ones of a plurality of different radial orientations or rotatably retained to each other in one of the plurality of different radial orientations.

Some embodiments of the invention provide that in directions along the first axis the reel assembly attachment position is located between the second portion and the second end. In certain embodiments of the invention, the second end is a forward end of the fishing pole handle from which a rod member is extendible away from the first portion.

Some embodiments of the invention provide that the first portion has an outer surface extending along and about the first axis, and the outer surface is configured to engage the foot of a reel assembly attachable to the fishing pole handle at the reel assembly attachment position. In certain embodiments of the invention the first portion is configured for attachment of a reel assembly to the outer surface with bindings that extend over the reel assembly foot and about the first axis; consequently, movement of a reel assembly when attached to the reel assembly attachment position is retained against movement toward the first end and about the first axis. According to some embodiments of the invention, the bindings include at least one zip tie.

In some embodiments of the invention, the outer surface is provided with a pocket configured to be receivable of a rearward end of the foot of a reel assembly attachable to the fishing pole handle; consequently, movement of a reel assembly when attached to the reel assembly attachment position is retained against movement toward the first end and about the first axis.

In certain embodiments of the invention, the pocket is a first pocket and the fishing pole handle includes a third portion configured to surround the outer surface at a location along the first axis between the first pocket and the second end, with the third portion defining a second pocket configured to be receivable of a forward end of the foot of the attachable reel assembly.

In some embodiments of the invention, the fishing pole handle includes a fourth portion configured to surround and securably engage the first portion. The fourth portion is abuttingly engageable with the third portion; consequently, movement of the third portion toward the second end along the first axis is constrained by abutment between the third and fourth portions, and movement of the third portion away from the second end along the first axis is constrained by the forward end of the foot of an attached reel assembly. In certain embodiments of the invention, the first and fourth portions are provided with cooperating threads and are securably engageable by being threadedly interconnected.

In some other embodiments of the invention, the first and third portions are provided with cooperating interlocking features and are securably engageable by the features being cooperatively interlocked. According to some such embodiments of the invention, the third portion has a central axis about which the third portion extends. The third and first portions are configured to permit relative sliding movement therebetween in both directions along the first axis when the central axis and the first axis are substantially parallel, and to prevent relative sliding movement therebetween in one direction along the first axis when the central axis and the first axis are substantially nonparallel.

Some embodiments of the invention provide that the third end extends about the first portion and surrounds the first axis. In certain embodiments of the invention, the second portion includes separable parts cooperatively interconnected to retain the third end in surrounding disposition about the first axis. According to some embodiments of the invention, the separable parts are cooperatively interconnected to retain the third end in surrounding disposition about the first axis through a joint extending between the third end and the fourth end.

Some embodiments of the invention of the invention provide that the first portion has an outer surface extending along and about the first axis, and the outer surface has a pair of substantially cylindrical first and second surface segments that are spaced along the first axis. The third end has a substantially cylindrical third surface segment disposed axially between the pair of first and second surface segments, and substantially cylindrical first, second and third surface segments are substantially located at a common radial distance from the first axis.

In some embodiments of the invention the second portion extends in a direction along the second axis between the substantially cylindrical third surface segment and the fourth end.

In some embodiments of the invention the second portion has an outer surface extending along and about the second axis between the substantially cylindrical third surface segment and the fourth end.

Some embodiments of the invention provide that the first portion has an axially interfacing pair of annular shoulders spaced in directions along the first axis, with the third end disposed along the first axis between the shoulders. Relative movement between the first and second portions in directions along the first axis is constrained by abutting engagement between the third end and the shoulders.

Some embodiments of the invention provide that the plurality of different radial orientations is a plurality of discrete (rather than generally different) radial orientations, and that the first portion and the second portion are rotatably retained to each other in each of the plurality of discrete radial orientations through the engagement of the coupling mechanism.

In some embodiments of the invention, the coupling mechanism includes a plurality of first voids in both the first portion and in the second portion, with each one of the plurality of first voids extending radially relative to the first axis. The plurality of first voids includes a plurality of second voids in either one of the first portion or the second portion, and a third void in the other one of the first portion or the second portion. In each of the plurality of discrete radial orientations, a respective one of the plurality of second voids, and the third void, are a pair of retention voids, the pair of retention voids radially aligned about the first axis. The coupling mechanism also includes a retention member disposed in each retention void of the pair of retention voids during engagement of the coupling mechanism, with the first and second portions rotatably retained in one of the plurality of discrete radial orientations through the engagement of the retention member with the pair of retention voids.

In some embodiments of the invention, the retention member is a set screw, and the pair of retention voids is a pair of holes, each hole receivable of the set screw. In certain embodiments of the invention, the retention void in either one of the first or second portion is a through hole, and the set screw is threadedly received into the retention void in the other one of the first or second portion.

In some embodiments of the invention, the retention member is moveable in substantially radial directions relative to the first axis, is biased in a substantially radial direction away from the first axis, and is captured in the retention void in the first portion with the coupling mechanism engaged and disengaged. The retention member is received into engagement with a respective retention void in the second portion during engagement of the coupling mechanism.

In some embodiments of the invention, the retention member is elongate and longitudinally parallel with the substantially radial directions in which the retention member is moveable. In certain such embodiments of the invention, the retention void in the second portion is a through hole through which the retention member is receivable.

In some embodiments of the invention, the retention void in the second portion is a cavity that is open in a radially inward direction relative to the first axis.

In some embodiments of the invention the retention member is substantially spherical.

Some embodiments of the invention provide that, relative to each other about the first axis, the first portion and the second portion have a plurality of discrete radial orientations. In each one of the plurality of discrete radial orientations, the first portion and the second portion are rotatably retained to each other about the first axis within a range of retention torque levels therebetween that is less than a respective breakaway torque level, and the first portion and the second portion are selectively relatively moveable about the first axis from one of the plurality of discrete radial orientations and toward another of the plurality of discrete radial orientations in response to being selectively urged about the first axis by an applied torque therebetween that exceeds the respective breakaway torque level.

In certain embodiments of the invention, a bore is provided in the first portion. The bore extends from a bore opening in the second end in a rearward direction that is generally along the first axis. The bore is receivable of a rod member.

The present invention includes, in another form thereof, a fishing pole assembly having a handle as described above and a rod member. The rod member has and extends between a rod member rear end and a rod member front end, and has a first longitudinal segment terminating at the rod member rear end and a second longitudinal segment terminating at the rod member front end. The rod member first longitudinal segment is disposed in the bore and affixed to the first portion. The rod member projects from the second end of the first portion in a forward direction that is generally along the first axis.

In some embodiments of the invention, the fishing pole assembly includes a plurality of guides affixed to the rod member at locations spaced along the rod member second longitudinal segment. In certain embodiments of the invention, the fishing pole assembly includes a reel assembly having a foot attached to the fishing pole handle at the reel assembly attachment position.

The present invention includes, in another form thereof, a fishing pole assembly having a fishing pole handle as described above, and a reel assembly having a foot attached to the fishing pole handle at the reel assembly attachment position.

### BRIEF DESCRIPTION OF THE DRAWINGS

The various objects, features and attendant advantages of the present invention will become fully appreciated as the same becomes better understood when considered in conjunction with the accompanying drawings. Although the drawings represent embodiments of the disclosed apparatus, the drawings are not necessarily to scale or to the same scale and certain features may be exaggerated or omitted in order to better illustrate and explain the present disclosure. Moreover, in accompanying drawings that show sectional views, cross-hatching of various sectional elements may have been omitted for clarity. It is to be understood that this omission of cross-hatching is for the purpose of clarity in illustration only.

FIG. 1 is a partial view of a fishing pole assembly according to a first embodiment of the present invention being held by a user's hand with one grip facilitated by the handle thereof;

FIG. 2 is a partial view of the fishing pole assembly shown in FIG. 1 being held by a user's hand with another grip facilitated by the handle thereof;

FIG. 3 is another view of the fishing pole assembly as held in FIG. 2;

FIG. 4 is a partial left side view of the fishing pole assembly and handle shown in FIGS. 1 to 3;

FIG. 5 is a partial right side view of the fishing pole assembly and handle shown in FIG. 4;

FIG. 6 is an exterior, perspective view of the two, separated halves of the second portion of the handle shown in FIGS. 1 to 5;

FIG. 7 is an interior, perspective view of the two, separated halves of the handle second portion shown in FIG. 6;

FIG. 8 is a partial cross-sectional view taken along line 8-8 of FIGS. 4, 9, 12, 14 and 17;

FIG. 9 is a partial left side view of a fishing pole assembly and handle according to a second, sixth, and seventh embodiment of the present invention;

FIG. 10 is an exterior, perspective view of the two, separated halves of the second portion of the handle shown in FIG. 9, FIG. 12, FIG. 18, and FIG. 25;

FIG. 11 is an interior, perspective view of the two, separated halves of the handle second portion shown in FIG. 10;

FIG. 12 is a partial left side view of a fishing pole assembly and handle according to a third embodiment of the present invention;

FIG. 13 is an enlarged side view of the retention member of the handle shown in FIG. 12;

FIG. 14 is a partial left side view of a fishing pole assembly and handle according to a fourth embodiment of the present invention;

FIG. 15 is an exterior, perspective view of the two, separated halves of the second portion of the handle shown in FIG. 14 or FIG. 17;

FIG. 16 is an interior, perspective view of the two, separated halves of the handle second portion shown in FIG. 15;

FIG. 17 is a partial left side view of a fishing pole assembly and handle according to a fifth embodiment of the present invention;

FIG. 18 is a partial right side view of a fishing pole assembly and handle according to a sixth embodiment of the present invention;

FIG. 19 is an upper, right front perspective view of the first portion of the handle shown in FIG. 18;

FIG. 20 is a lower, right front perspective view of the handle first portion shown in FIG. 19;

FIG. 21 is a perspective view of the first end of the reel assembly foot retainer of the handle of the fishing pole assembly shown in FIG. 18;

FIG. 22 is a perspective view of the second end of the foot retainer shown in FIG. 21;

FIG. 23 is a perspective view of the first end of the reel assembly foot retainer keeper of the handle of the fishing pole assembly shown in FIG. 18;

FIG. 24 is a perspective view of the second end of the foot retainer keeper shown in FIG. 23;

FIG. 25 is a partial right side view of a fishing pole assembly and handle according to a seventh embodiment of the present invention;

FIG. 26 is an upper, right front perspective view of the first portion of the handle of the fishing pole assembly shown in FIG. 25;

FIG. 27 is a lower, left front perspective view of the handle first portion shown in FIG. 26;

FIG. 28 is an upper perspective view of the first end of the reel assembly foot retainer of the handle of the fishing pole assembly shown in FIG. 25;

FIG. 29 is a lower perspective view of the second end of the foot retainer shown in FIG. 28; and

FIG. 30 is a front perspective view a longitudinal cross-section of an exemplary embodiment of a handle first portion according to the present invention.

Corresponding reference characters indicate corresponding parts throughout the several views. The exemplary embodiments set forth herein are not to be construed as limiting the scope of the invention in any manner.

### DETAILED DESCRIPTION OF EMBODIMENT(S)

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

Exemplary apparatus and system embodiments according to the present disclosure are described below in detail with reference to the accompanying drawings. In the following detailed description, numerous specific details are set forth in order to provide a thorough understanding of the present invention. It will, however, be obvious to those of ordinary skill in the relevant art that the present invention may be practiced without these specific details. In other instances, well-known structures are not shown in detail in order to avoid unnecessary obscuring of the present invention.

Furthermore, there is no intention to be bound by any expressed or implied theory presented in the preceding technical field, background, brief summary or the following detailed description. It is also to be understood that the specific embodiments illustrated in the attached drawings and described herein are simply exemplary embodiments of the inventive concepts defined by the appended claims. Hence, specific dimensions and other physical characteristics relating to the embodiments disclosed herein are not to be considered as limiting, except as claimed.

The following are descriptions of fishing pole assemblies and fishing pole handles for use therewith according to various embodiments of the present invention, wherein, unless indicated otherwise, reference numerals absent a letter suffix refer generally to one or more depicted embodiments, and reference numerals including a letter suffix (e.g., A, B, C, D, E, F, or G) refer particularly to respective embodiments. Further, in some instances, the respective components or configurations of different fishing pole assembly or handle embodiments may be substantially identical to those of other embodiments. Hence, certain Figures show common aspects of different fishing pole assembly and handle embodiments.

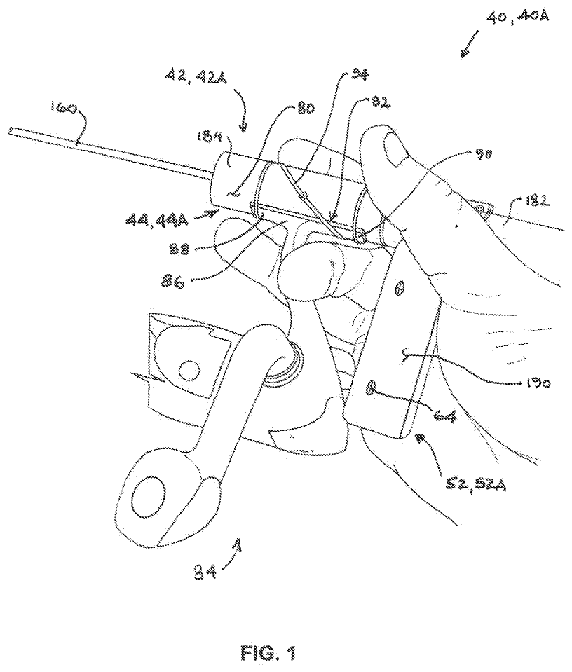

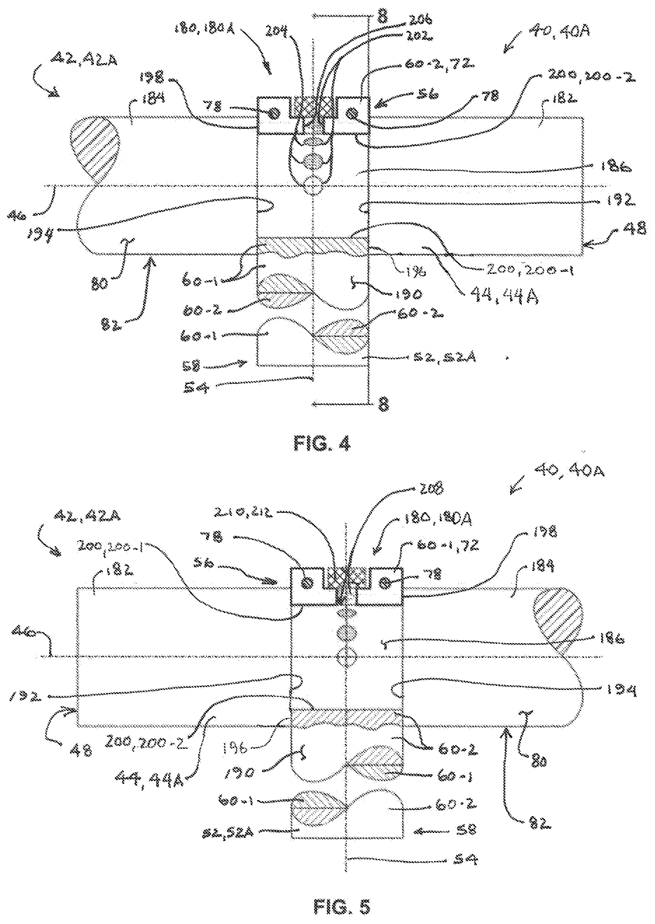

FIGS. 1 to 7 depict fishing pole assembly 40A, handle 42A, and components thereof according to a first embodiment of fishing pole assembly 40 and handle 42. FIG. 8 is a partial cross-sectional view taken along line 8-8 of FIG. 4.

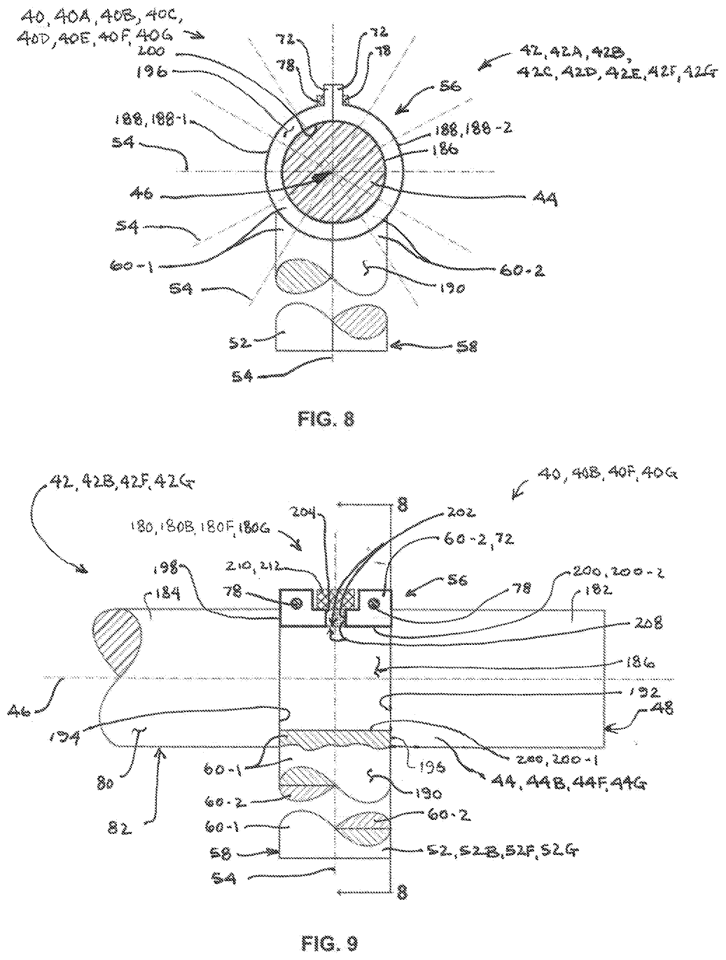

FIGS. 9 to 11 depict fishing pole assembly 40B, handle 42B, and components thereof according to a second embodiment of fishing pole assembly 40 and handle 42. FIG. 8 is a partial cross-sectional view taken along line 8-8 of FIG. 9.

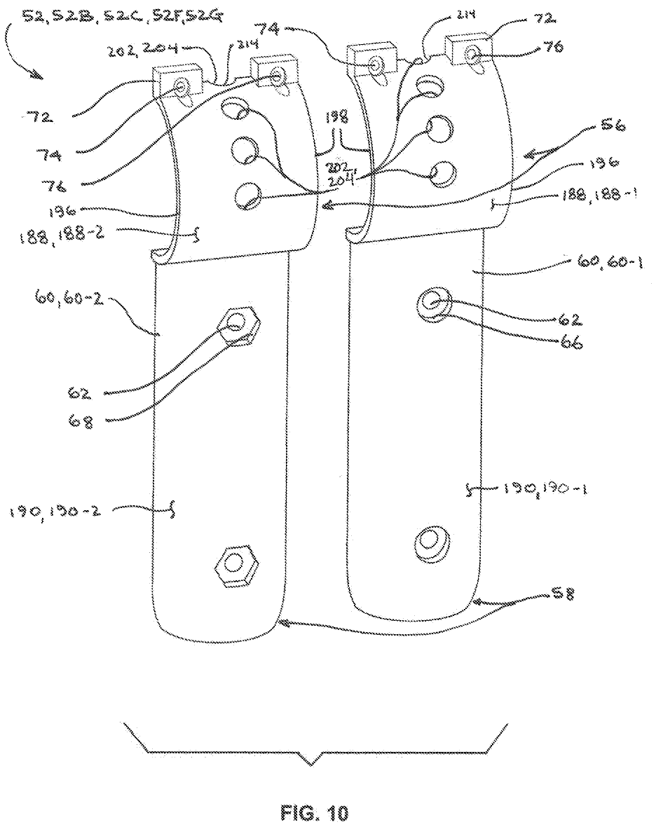

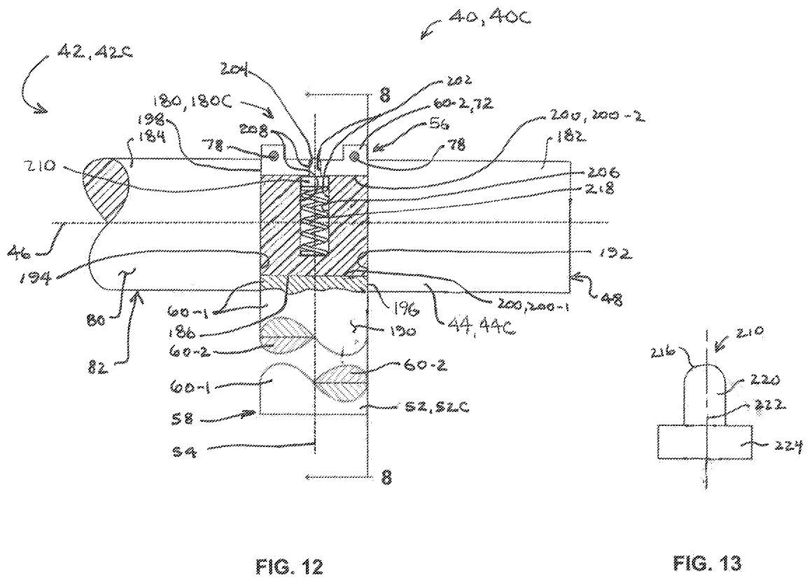

FIGS. 10 to 13 depict fishing pole assembly 40C, handle 42C, and components thereof according to a third embodiment of fishing pole assembly 40 and handle 42. FIG. 8 is a partial cross-sectional view taken along line 8-8 of FIG. 12.

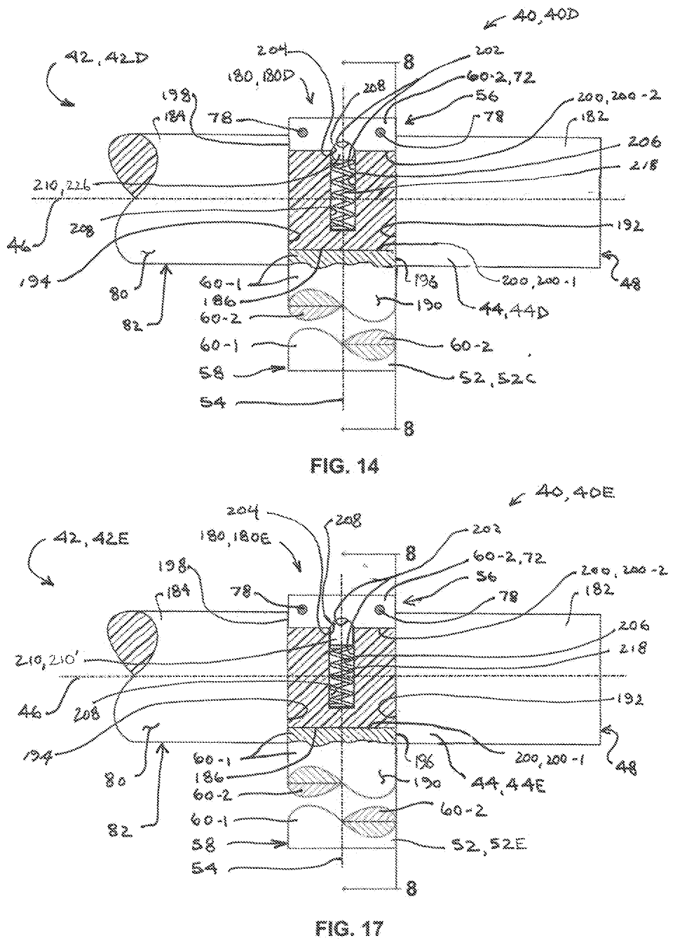

FIGS. 14 to 16 depict fishing pole assembly 40D, handle 42D, and components thereof according to a fourth embodiment of fishing pole assembly 40 and handle 42. FIG. 8 is a partial cross-sectional view taken along line 8-8 of FIG. 14.

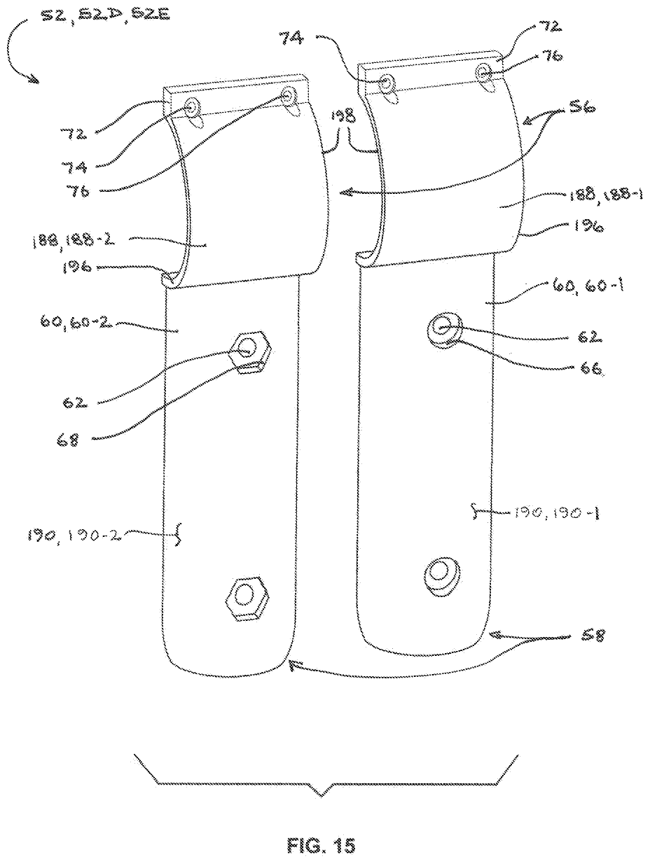

FIGS. 15 to 17 depict fishing pole assembly 40E, handle 42E, and components thereof according to a fifth embodiment of fishing pole assembly 40 and handle 42. FIG. 8 is a partial cross-sectional view taken along line 8-8 of FIG. 17.

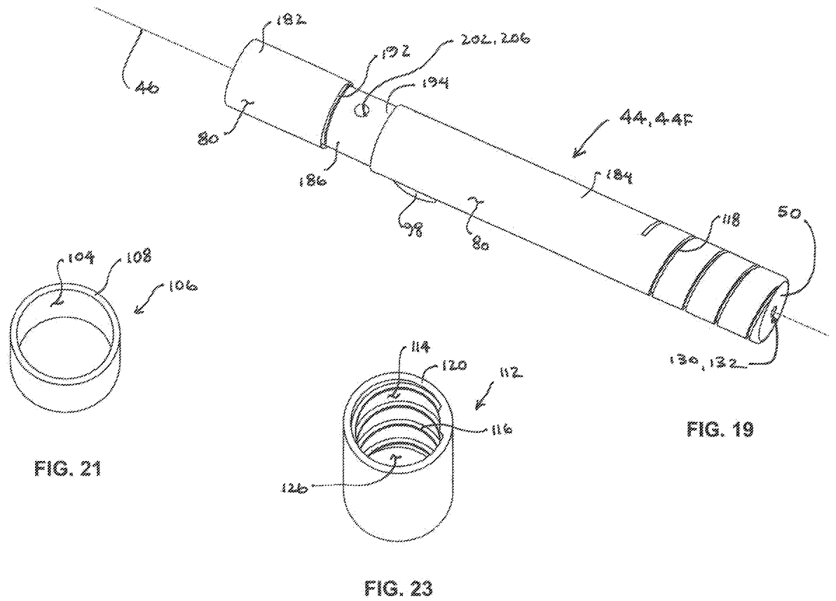

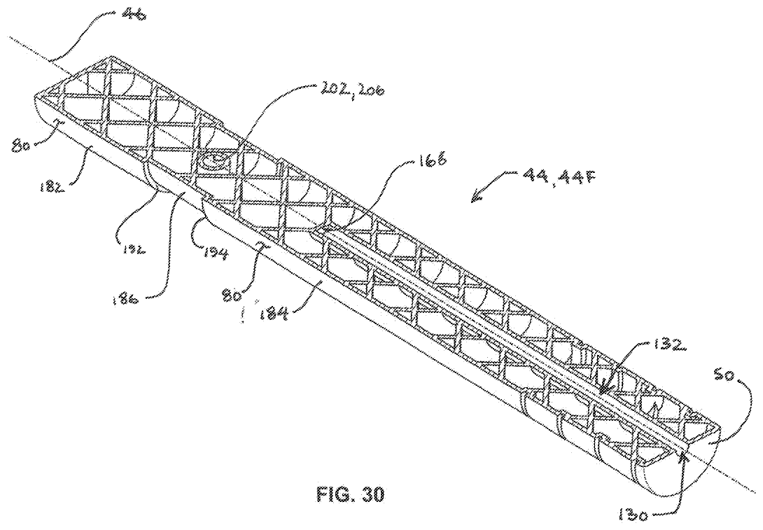

FIGS. 9, 10, 11, and 18 to 24 depict fishing pole assembly 40F, handle 42F, and components thereof according to a sixth embodiment of fishing pole assembly 40 and handle 42. FIG. 8 is a partial cross-sectional view taken along line 8-8 of FIG. 9. FIG. 30 is a front perspective view a longitudinal cross-section of exemplary handle first portion 44F, which shows certain internal structural features incorporated into certain embodiments of handle first portion 44 according to the present invention. It is to be understood that embodiments of handle second portion 52 may incorporate similar internal structural features.

FIGS. 9, 10, 11, and 25 to 29 depict fishing pole assembly 40G, handle 42G, and components thereof according to a seventh embodiment of fishing pole assembly 40 and handle 42. FIG. 8 is a partial cross-sectional view taken along line 8-8 of FIG. 9.

As variously shown in the Figures, according to the present invention, each embodiment of fishing pole assembly 40 includes fishing pole handle 42. Handle 42 includes elongate, generally cylindrical first portion 44 which extends along first axis 46 and has spaced first end (or rear end) 48 and longitudinally opposite second end (or front end) 50. In the depicted embodiments, first end 48 and second end 50 are circular, planar, parallel to each other, and normal to first axis 46.

Handle 42 also includes elongate, generally cylindrical second portion 52 which extends along second axis 54, which is substantially perpendicular to first axis 46. Second portion 52 has spaced third end 56 and longitudinally opposite fourth end 58. In the depicted embodiments, third end 56 extends about and completely surrounds first axis 46. Fourth end 58 is circular, planar and normal to second axis 54. Certain embodiments of handle first portion 44 and/or second portion 52 are integrally formed, as by 3D printing or injection molding techniques utilizing a suitable plastic material. Suitable plastic materials include, without limitation, ABS and PLA thermoplastic polymers.

Handle second portion 52 is spaced from first end 48 and second end 50 of handle first portion 44. Third end 56 of handle second portion 52 is rotatably connected to handle first portion 44 about first axis 46.

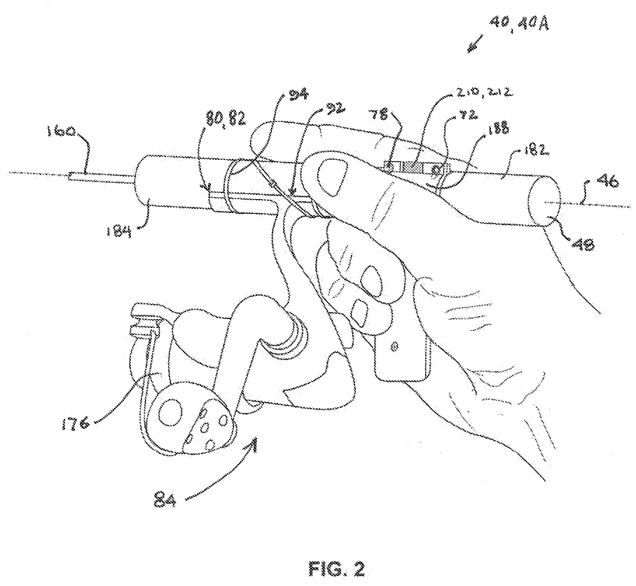

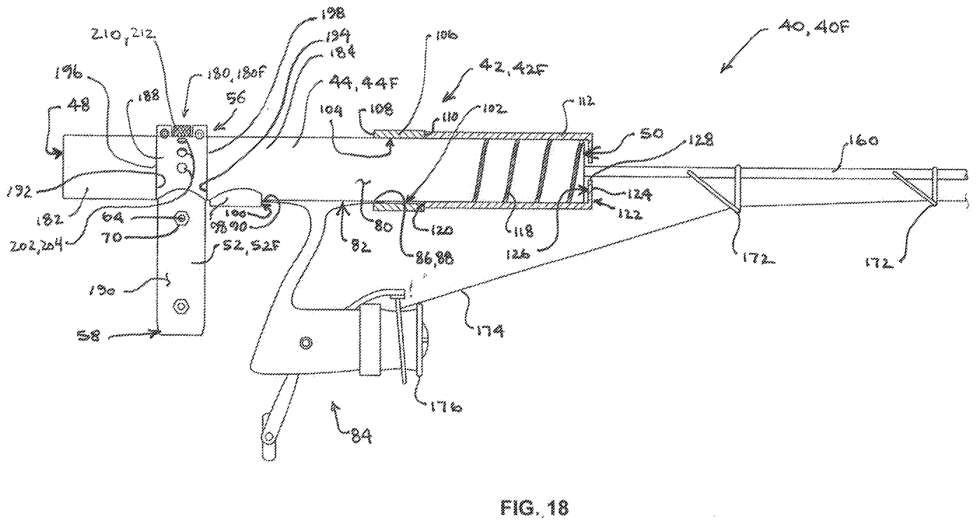

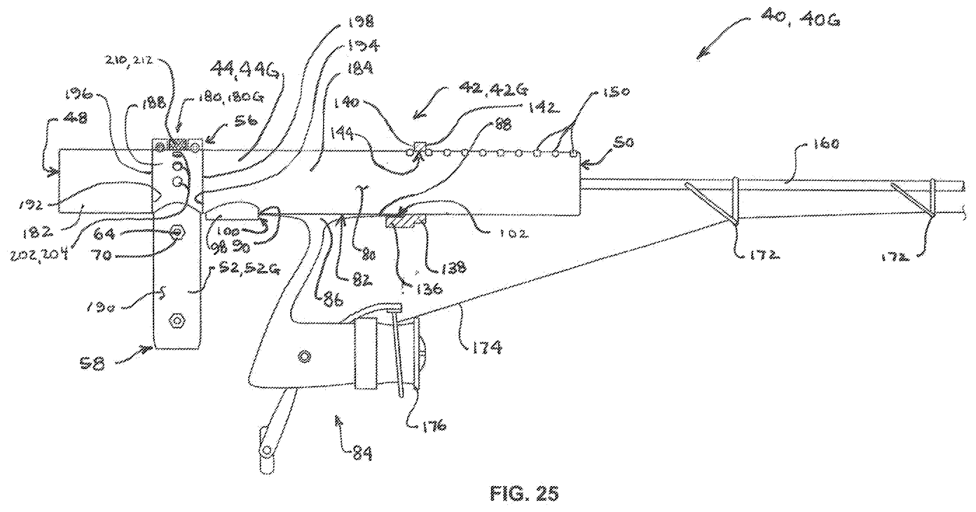

In certain embodiments, as depicted, handle second portion 52 includes separable parts 60, which in the depicted embodiments are first and second halves 60-1 and 60-2, respectively. As used herein, “separable parts” means parts joinable together into an operable state, from an inoperable state in which the parts are entirely or partially unjoined. First and second halves 60-1, 60-2 include pairs of mating holes 62 through which extend machine screws 64 for attaching halves 60-1 and 60-2 together. In the depicted embodiments, the external, cylindrical surface portion of first half 60-1 includes cylindrical countersinks 66 about its holes 62 for receiving the heads of screws 64 (shown in FIGS. 1 and 2), and the external, cylindrical surface portion of second half 60-2 includes hexagonal countersinks 68 about its holes 62 for receiving nuts 70 (shown in FIGS. 18 and 25) that threadedly engage screws 64, thereby securing second portion halves 60-1 and 60-2 together and about first axis 46.

In the depicted embodiments, second portion halves 60-1 and 60-2 include mating flanges 72 at third end 56. In certain embodiments, as shown, a clearance hole 74 and a thread engagement hole 76 are included in the flange(s) 72 of each half 60-1, 60-2. With halves 60-1 and 62-2 assembled to each other, and disposed about first axis 46, a respective clearance hole 74 and thread engagement hole 76 are aligned with each other and receivable of a self-tapping screw 78. In the depicted embodiments, two (2) self-tapping screws 78 hold separable parts 60 together at third end 56. As depicted, in certain embodiments of handle second portion 52 the separable halves 60-1, 60-2 are individually formed, as by 3D printing or injection molding techniques utilizing a suitable plastic material, and interconnected utilizing threaded fasteners as described above.

Alternatively, in certain unshown embodiments of handle second portion 52, halves 60-1, 60-2 are separable about, and hingedly interconnected by one or more living hinges located along halves 60-1 and 60-2 at the terminus of third end 56, the hinge(s) configured to pivot about and extend along a pivot axis that, when handle second portion 52 is assembled to handle first portion 44, is parallel to first axis 46. In such alternative embodiments, holes 74, 76 and screws 78, indeed, flanges 72 themselves, are obviated. In such alternative embodiments of handle second portion 52, its halves 60-1 and 60-2, and the interconnecting living hinge(s) therebetween, are integrally formed, as by 3D printing or injection molding techniques utilizing a suitable plastic material, e.g., ABS or PLA.

As a further alternative, in certain unshown embodiments of second portion 52 separable halves 60-1, 60-2 are individually formed, as by 3D printing or injection molding techniques utilizing a suitable plastic material, to incorporate mutually interconnecting features in their mating flanges 72 through which halves 60-1, 60-2 may be selectively joined at terminus of third end 56. In such alternative embodiments, holes 74, 76 and screws 78 are obviated.

Handle first portion 44 has substantially cylindrical outer surface 80 providing reel assembly attachment position 82 of handle 42. Certain embodiments of fishing pole assembly 40 include reel assembly 84 attached to handle 42 at reel assembly attachment position 82, at a radially fixed orientation about first axis 46 and an axially fixed location in directions along first axis 46. In the depicted embodiments, handle first portion 44 is configured to engage reel assembly foot 86, which is elongate and extends between foot forward end 88 and foot rearward end 90. Foot upper mounting surface 92 is located between foot forward and rearward ends 88, 90 and interfaces reel assembly attachment position 82. Embodiments of fishing pole assembly 40 according to the present invention include various means for attachment of reel assembly 84 to handle 42, as described further below.

Referring to FIGS. 1 to 3, in first embodiment fishing pole assembly 40A reel assembly 84 is attached to handle 42A by bindings 94 that tightly entwine handle first portion 44A and portions of reel assembly foot 86, thereby retaining foot upper mounting surface 92 to reel assembly attachment position 82 of handle 42A. Bindings 94 may, for example, comprise a single zip tie 94 or a plurality of individual or interconnected zip ties 94, of a type well known in the relevant art and which may be made of nylon.

Fishing pole assembly 40B, 40C, 40D or 40E, and/or handle 42B, 42C, 42D or 42E, may be similarly configured to include the structure, componentry and/or methods described above regarding fishing pole assembly 40A and/or handle 42A, for attaching a reel assembly 84 thereto.

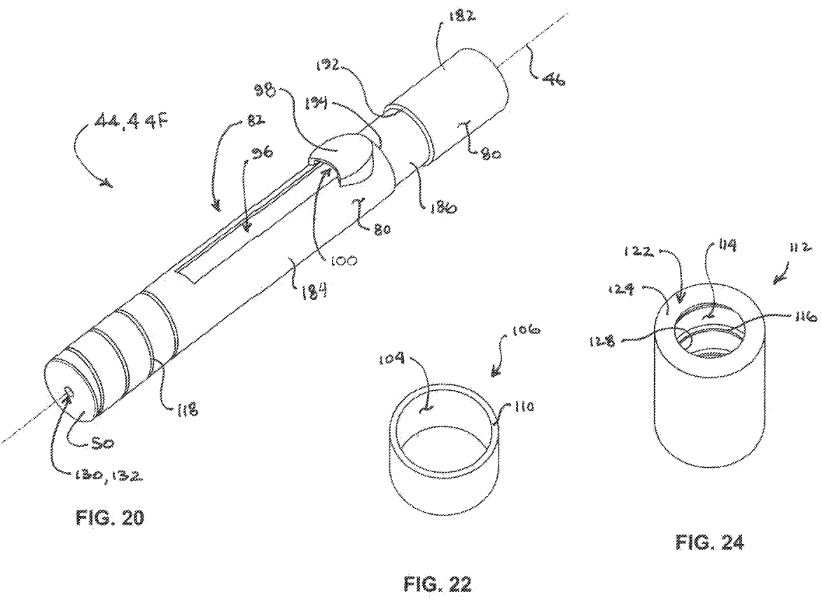

Referring to FIGS. 18 to 24, in sixth embodiment fishing pole assembly 40F, reel assembly attachment position 82 is within longitudinal recess 96 provided in cylindrical outer surface 80 of handle first portion 44F. Referring to FIGS. 18 and 20, the floor of recess 96 engages upper mounting surface 92 of reel assembly foot 86. Boss 98 provided in handle first portion 44F extends over the rear portion of recess 96 to form first pocket (or rear pocket) 100 of handle first portion 44F.

Second pocket (or front pocket) 102 formed by the portion of cylindrical inner surface 104 of handle third portion (or foot retainer) 106 that extends over and interfaces the front portion of recess 96. Referring to FIGS. 18, 21 and 22, foot retainer 106 defines a right cylinder having identical, annular, axially opposed first and second axial end surfaces 108, 110. With fishing pole assembly 40F assembled as shown in FIG. 18, first axial end surface 108 designates the rear end surface of foot retainer 106, and second axial end surface 110 designates its front end surface. As one having ordinary skill in the relevant art is aware, reel assembly foot 86 is configured to have a greater thickness from its upper mounting surface 92 near the midpoint between its forward and rearward ends 88, 90, toward which foot 86 is sloped to relatively lesser thicknesses. During assembly of fishing pole assembly 40F, rearward end 90 of reel assembly foot 86 is received within first pocket 100, and second pocket 102 is formed over forward end 88 of foot 86, thereby capturing foot ends 88 and 90 within pockets 102 and 100, and retaining reel assembly 84 to handle 42F. As foot rearward end 90 is inserted into rear pocket 100, the sloped surface of foot 86 proximate to foot rearward end 90 snugly engages boss 98, securing foot 86 between boss 98 and the floor of recess 96. Foot retainer 106 is then slidably received over front end 50 of handle first portion 44F and over forward end 88 of reel assembly foot 86, which is disposed in recess 96. More particularly, foot retainer rear end surface 108 is then positioned along foot 86 until the sloped surface of foot 86 proximate to foot forward end 88 snugly engages cylindrical surface 104 of foot retainer 106, securing foot 86 between surface 104 and the floor of recess 96.

Referring to FIGS. 18, 23 and 24, handle 42F includes generally cylindrical fourth portion (or foot retainer keeper) 112 that defines a right cylinder which is threadedly received upon the forward portion of cylindrical outer surface 80 of handle first portion 44F. Foot retainer keeper (or handle fourth portion) 112 has cylindrical inner surface 114 on which is formed helical thread 116 (FIG. 23) that engages mating helical thread 118 formed in the cylindrical outer surface 80 of handle first portion 44F and which extends rearward from second end 50 thereof.

Cylindrical foot retainer keeper 112 has annular first axial end surface (or rear end surface) 120 from which helical thread 116 extends, and annular, axially opposed second axial end surface (or front end surface) 122. Referring to FIG. 18, front end surface 122 is defined by planar, annular flange 124 having rearward-facing side 126 facing the interior of foot retainer keeper 112. Flange 124 is provided with centrally positioned, round aperture 128 that, when foot retainer keeper 112 threadedly received upon handle first portion 44F, is concentric with first axis 46 and opening 130 of bore 132 which is located in second end (or front end) 50 of handle first portion 44, 44F. As best seen in FIG. 30, in embodiments of fishing pole assembly 40 and/or handle 42, bore 132 extends in a rearward direction from front end 50 and, as described further below, is receivable of a rod member inserted through opening 130.

Returning to FIG. 18, with reel assembly foot 86 secured between cylindrical inner surface 104 of foot retainer 106 and the floor of recess 96, foot retainer keeper 112 is rotated relative to handle first portion 44F, on which it is threadedly received, until annular rear end surface 120 of foot retainer keeper 112 is brought into compressive, abutting engagement with annular front end surface 110 of foot retainer 106, thereby preventing movement of reel assembly foot 86 relative to handle first portion 44F. As shown in FIG. 18, with annular rear end surface 120 of foot retainer keeper 112 and annular front end surface 110 of foot retainer 106 abuttingly engaged, rearward-facing side 126 of flange 124 of foot retainer keeper 112 is axially spaced from front end 50, whereby fishing pole assembly 40F may comprise various reel assemblies 84 of differing foot lengths.

Fishing pole assembly 40B, 40C, 40D or 40E, and/or handle 42B, 42C, 42D or 42E, may be similarly configured to include the structure, componentry and/or methods described above regarding fishing pole assembly 4F and/or handle 42F, for attaching a reel assembly 84 thereto.

Referring now to FIGS. 25 to 29, in seventh embodiment fishing pole assembly 40G, reel assembly attachment position 82 is within longitudinal recess 96 provided in cylindrical outer surface 80 of handle first portion 44G. Referring to FIGS. 25 and 27, the floor of recess 96 engages upper mounting surface 92 of reel assembly foot 86. Boss 98 extends over the rear portion of recess 96 to form first pocket (or rear pocket) 100 (FIG. 27) of handle first portion 44G.

Second pocket (or front pocket) 102 (FIG. 25) is formed by the surface of rearwardly projecting tab 136 of annular handle third portion (or foot retainer) 138 that extends over and interfaces the front portion of recess 96. Referring to FIGS. 25, 28 and 29, foot retainer 138 defines a ring having annular first axial end surface (or rear end surface) 140 (FIG. 28), and annular, axially opposed second axial end surface (or front end surface) 142 (FIG. 29). Extending between first and second axial end surfaces 140, 142 is cylindrical inner surface 144 of foot retainer 138.

Referring still to FIGS. 28 and 29, foot retainer 138 has sharp, right or acutely angled, circumferentially extending, rearward corner 146 formed by the junction of annular axial rear end surface 140 and cylindrical inner surface 144, and sharp, right or acutely angled, circumferentially extending, forward corner 148 formed by the junction of annular axial front end surface 142 and cylindrical inner surface 144.

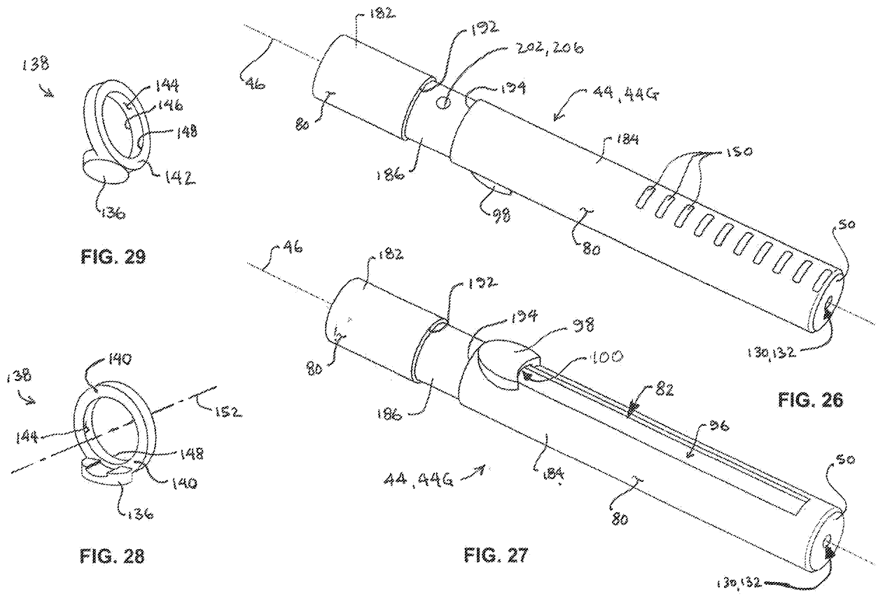

As shown in FIGS. 25 and 26, the forward portion of handle first portion 44G includes a plurality of arcuate, parallel, circumferentially extending humped bosses 150 located on and longitudinally distributed along cylindrical outer surface 80, diametrically opposite longitudinal recess 96. Each humped boss 150 is disposed in a respective imaginary plane that is normal to first axis 46. Cylindrical inner surface 144 is concentric about central axis 152 of foot retainer 138 (FIG. 28), and has a diameter that permits passage of foot retainer over cylindrical surface 80 and each humped boss 150 with only minimal clearance, with central axis 152 and first axis 46 substantially parallel.

As shown in FIG. 25, the shortest distance along cylindrical surface 80 between adjacent ones of the plurality of humped bosses 150 closely accommodates the axial distance between circumferentially extending rearward and forward corners 146, 148 of foot retainer 138. During assembly of fishing pole assembly 40G, rearward end 90 of reel assembly foot 86 is received within first pocket 100, and second pocket 102 is formed over forward end 88 of foot 86, thereby capturing foot ends 88 and 90 within pockets 102 and 100, and retaining reel assembly 84 to handle 42G. As foot rearward end 90 is inserted into rear pocket 100, the sloped surface of foot 86 proximate to foot rearward end 90 snugly engages boss 98, securing foot 86 between boss 98 and the floor of recess 96. Foot retainer 138 is then slidably received over front end 50 of handle first portion 44G and over forward end 88 of reel assembly foot 86, which is disposed in recess 96. More particularly, foot retainer tab 136 is positioned along foot 86 until the sloped surface of foot 86 proximate to foot forward end 88 snugly engages the surface of tab 136 of foot retainer 138, securing foot 86 between tab 138 and the floor of recess 96. The snug engagement between reel assembly foot 86 and foot retainer 138 urges central axis 152 and first axis 46 into a substantially nonparallel orientation relative to each other, whereby, along first axis 46, foot retainer 138 is disposed at an angle, or cocked, relative to cylindrical outer surface 80 of handle first portion 44G. When central axis 152 and first axis 46 are substantially nonparallel, at least one of sharp rearward and forward corners 146, 148 of foot retainer 138, and at least one of humped bosses 150, cooperatively interlock, thereby engaging with each other to prevent relative sliding movement between foot retainer 138 and handle first portion 44G. One having ordinary skill in the relevant art will appreciate that the manner of their engagement is effectively similar to that of a jam nut pressed onto a relatively soft post.

Referring to FIGS. 25 to 27, owing to the large number of humped bosses 150, the substantial length of longitudinal recess 96, and their close proximities to second end 50 of handle first portion 44G, fishing pole assembly 40G may comprise different reel assemblies 84 having various foot lengths.

Fishing pole assembly 40B, 40C, 40D or 40E, and/or handle 42B, 42C, 42D or 42E, may be similarly configured to include the structure, componentry and/or methods described above regarding fishing pole assembly 40G and/or handle 42G, for attaching a reel assembly 84 thereto.

As best shown in FIGS. 1 to 3, embodiments of fishing pole assembly 40 according to the present invention include rod member 160 of a commercially available type known in the art. Rod member 160 may, for example, comprise a flexible, solid graphite, solid fiberglass, or solid graphite/fiberglass composite rod blank of a type commercially available from, for example, Jann's Netcraft® of Maumee, Ohio, (www.jannsnetcraft.com). Rod member 160 extends between a terminal first end (or rear end or butt end) and a longitudinally opposite, terminal second end (or front end or tip end) thereof. Some embodiments of rod member 160 have an overall length in a range between approximately 12 inches to 48 inches, and may be tapered from its first end to its second end. Certain such tapered rod member embodiments have a first end diameter in a range between approximately 0.125 inch to approximately 0.180 inch; and a second end diameter in a range between approximately 0.031 inch to approximately 0.094 inch. One having ordinary skill in the relevant art will understand rod member 160 to include at least a first longitudinal segment that extends from its first end towards its second end, and a second longitudinal segment that extends from its second end towards its first end.

Referring again to FIG. 30, bore 132 of handle first portion 44, extends in a rearward direction along first axis 46 from its opening 130 located in second end (or front end) 50 to end wall 166 located within first portion 44. The diameter of bore 132 is substantially consistent along its length, and is receivable, via opening 130, of the butt end of rod member 160 and at least a portion of the first longitudinal segment of rod member 160, which is adhered to the generally cylindrical interior wall of bore 132 with a suitable glue or cement. The second longitudinal segment of rod member 160 is disposed externally of second end 50 of handle first portion 44, and extends toward the tip end of rod member 160. In its natural, relaxed state, installed rod member 160 extends substantially along first axis 46.

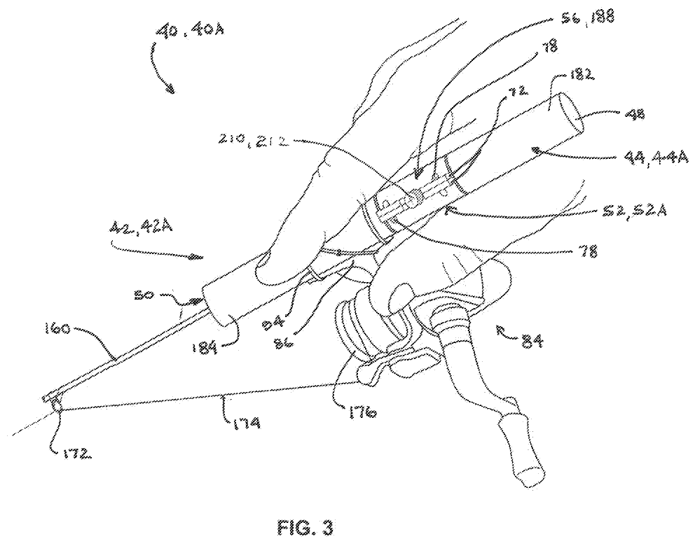

FIGS. 3, 18 and 25 show a plurality of axially spaced guides 172 that have been affixed in a known way (e.g., by being tied or adhered) to rod member 160. Guides are of a type commercially available from, for example, above-mentioned Jann's Netcraft, and have openings through which extends fishing line 174 that is alternatively collected and stored, or dispensed from spool 176 of reel assembly 84. The openings of guides 172 affixed to rod member 160 and reel assembly attachment position 82 of handle 42 are generally aligned radially relative to first axis 46. Because reel assembly 84, and fishing line 174 as it extends along rod member 160 often tend to remain located below handle 42 during use of fishing pole assembly 40, it is desirable to facilitate repositioning handle second portion 52 between, and retaining second portion 52 in, a plurality of different radial orientations relative to handle first portion 44, about first axis 46, preferably easily and without the use of tools, to promote user comfort and ergonomic handling of fishing pole assembly 40. Handle 42 of fishing pole assembly 40 facilitates such repositioning and retaining through use of selectively engageable coupling mechanism 180 between handle first portion 44 and handle second portion 52.

In exemplary handle 42 embodiments described herein, handle first and second portions 44, 52 are constrained against relative movement in directions along first axis 46 but, relative to each other about first axis 46, first and second portions 44, 52 are selectively moveable between alternative ones of a plurality of different, indeed discrete (i.e., individually separate and distinct) radial orientations or rotatably retained to each other in one of the plurality of discrete radial orientations. Handle first and second portions 44, 52 are rotatably retainable to each other about first axis 46 through engagement of coupling mechanism 180, and are relatively moveable about first axis 46 through disengagement of coupling mechanism 180. The configuration and operation of coupling mechanism 180 varies between certain embodiments of fishing pole assembly 40 and handle 42 according to the present invention, as described further below.

In the various embodiments of handle 42 described herein, cylindrical outer surface 80 of handle first portion 44 includes cylindrical first surface segment (or rear surface segment) 182 and cylindrical second surface segment (or front surface segment) 184 that are separated from each other and spaced along first axis 46. Cylindrical first and second surface segments 182, 184 are concentric about and substantially equidistant from first axis 46. Axially between and concentric with first and second surface segments 182, 184, handle first portion 44 provides cylindrical outer bearing surface 186 that is of a diameter relatively smaller than the diameter of surface 80. Third end 56 of handle second portion 52 is disposed axially between first and second surface segments 182, 184 and surrounds cylindrical outer bearing surface 186, as described further below.

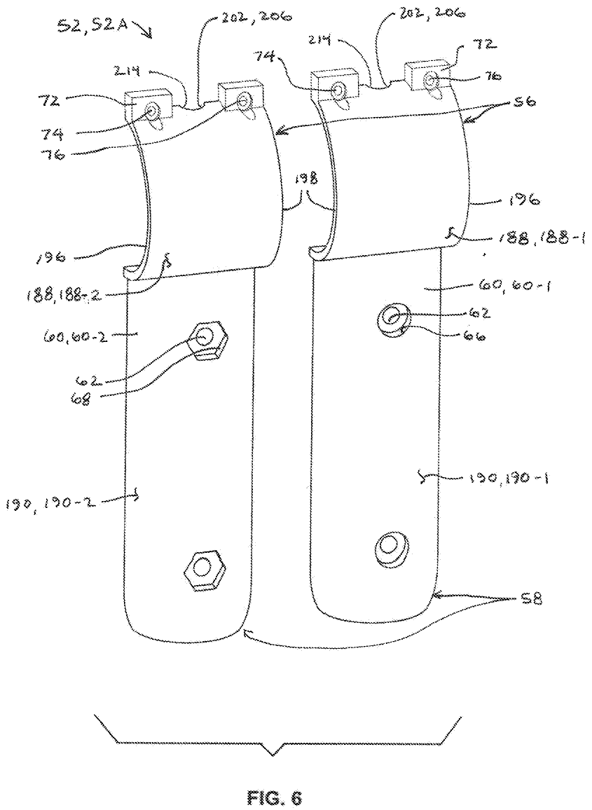

Referring to FIG. 8, third end 56 of handle second portion 52 defines cylindrical third surface segment 188 comprising first half 188-1 and second half 188-2, which are respectively provided on first half 60-1 and second half 60-2 of handle second portion 52, as best shown in FIGS. 6, 10 and 15. Handle second portion 52 also has generally cylindrical outer surface 190 that extends between third and fourth ends 56, 58 along and concentrically about second axis 54. Generally cylindrical outer surface 190 comprises first half 190-1 and second half 190-2 provided on first half 60-1 and second half 60-2 of handle second portion 52, as also best shown in FIGS. 6, 10 and 15.

Referring to FIGS. 4, 5, 9, 12, 14 and 17, handle first portion 44 defines annular rear shoulder 192 located between cylindrical first surface segment 182 and cylindrical outer bearing surface 186, and annular front shoulder 194 located between cylindrical second surface segment 184 and cylindrical outer bearing surface 186. Annular rear shoulder 192 and annular front shoulder 194 slidably engage interfacing annular rear face 196 and annular front face 198 located on the axially opposite ends of cylindrical third end 56. As best shown in FIGS. 6, 7, 10, 11, 15 and 16, each of handle second portion halves 60-1 and 60-2 defines one half of annular rear face 196 and one half of annular front face 198. Third end 56 of handle second portion 56 also forms cylindrical inner bearing surface 200, which is concentric with cylindrical third surface segment 188. Cylindrical inner bearing surface 200 comprises first half 200-1 and second half 200-2 provided on first half 60-1 and second half 60-2 of handle second portion 52 and, as shown in FIGS. 4, 5, 9, 12, 14 and 17, slidably interfaces cylindrical outer bearing surface 186 of handle first portion 44.

In the various embodiments of handle 42 described herein, coupling mechanism 180 includes a plurality of first voids 202 that are located in both handle first portion 44 and handle second portion 52. First voids 202 include a plurality of second voids 204 and a third void 206. Second voids 204 are located in either one of handle first portion 44 or handle second portion 52; third void 206 is located in the other one of handle first portion 44 or handle second portion 52. One of the second voids 204 and the third void 206 define a radially aligned pair of retention voids 208 in each of the above-mentioned plurality of discrete radial orientations between handle first portion 44 and handle second portion 52. In a radially aligned pair of retention voids 208, the retention void located in handle first portion 44 is designated 208-1, and the retention void located in handle second portion 52 is designated 208-2.

Coupling mechanism 180 includes substantially rigid retention member 210, some embodiments of which is metal or a suitably hard plastic, that engages the aligned pair of retention voids 208 in each respective one of the contemplated plurality of discrete radial orientations between handle first portion 44 and handle second portion 52. In the exemplary embodiments of fishing pole assembly 40 and handle 42 described herein, coupling mechanism 180 facilitates, relative to handle first portion 44, the selective movement of cylindrical outer surface 190 of handle second portion 52 between, and its retention in, a plurality of discrete positions that are located in or beneath the imaginary horizontal plane shown in FIG. 8. As depicted, seven (7) discrete positions are located in a 180° arc about first axis 46, angularly spaced at 30° intervals. Hence, there are seven (7) different pairs of retention voids 108 in the exemplary embodiments.

Coupling mechanism 180A of handle 42A and fishing pole assembly 40A, which selectively engages handle first and second portions 44A and 52A thereof, is depicted in FIGS. 4 and 5. In coupling mechanism 180A, retention member 210 is set screw 210 having a cylindrical head 212 that is knurled to facilitate turning with fingers.

In coupling mechanism 180A, the plurality of first voids 202 is located in cylindrical outer bearing surface 186 of handle first portion 44A, and between flanges 72 at third end 56 of handle second portion 52A.

In coupling mechanism 180A, the plurality of second voids 204 included amongst first voids 202 comprises seven (7) threaded holes 204 located in an imaginary plane that is normal to first axis 46. As depicted, this imaginary plane contains second axis 54 and is axially located centrally between shoulders 192, 194. Threaded holes 204 extend radially toward first axis 46 and are angularly spaced at 30° intervals thereabout.

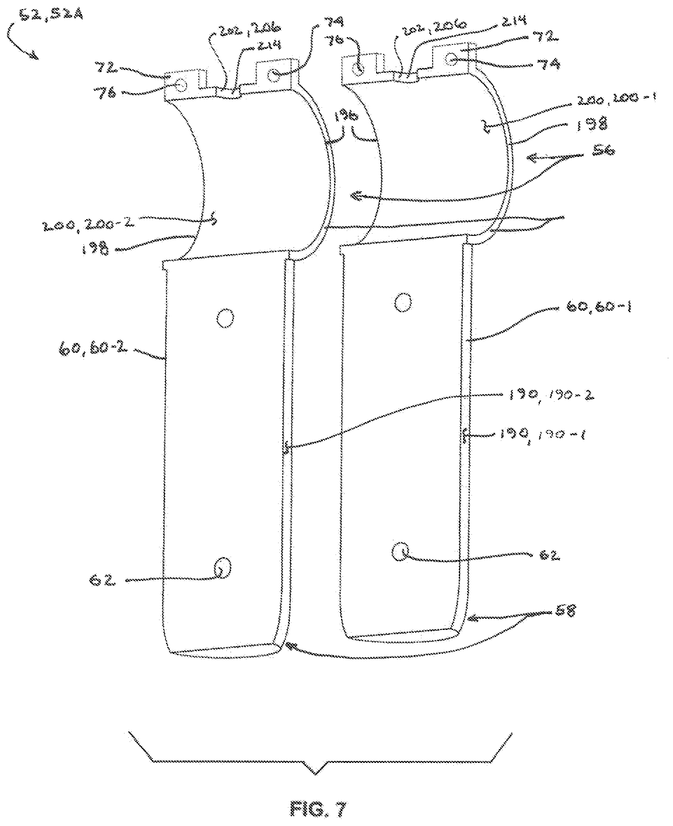

In coupling mechanism 180A, third void 206 included amongst first voids 202 is the singular through hole 206 located in the above-mentioned imaginary plane that is normal to first axis 46, and between flanges 72 at third end 56 of handle second portion 52A, along the joint between second portion halves 60-1 and 60-2, as best seen in FIGS. 6 and 7. As shown, second portion halves 60-1 and 60-2 are provided with semicircular voids in their mutually abutting edges between flanges 72 that, when the halves are mated, form circular through hole 206 that is receivable of set screw 210. To engage coupling mechanism 180A, through hole 206 and a desired one of threaded holes 204 are radially aligned to establish the pair of retention voids 208, and set screw 210 is received therein to mutually retain handle first and second portions 44A, 52A in the desired radial orientation. Set screw 210 is removed to disengage coupling mechanism 180A.

The respective coupling mechanism 180F or 180G of fishing pole assembly 40F or 40G and/or handle 42F or 42G may be similarly configured to include the structure, componentry and/or methods described above regarding coupling mechanism 180A of fishing pole assembly 40A and/or handle 42A.

Coupling mechanism 180B of handle 42B and fishing pole assembly 40B, which selectively engages handle first and second portions 44B and 52B thereof, is depicted in FIG. 9. In coupling mechanism 180B, retention member 210 is set screw 210 having a cylindrical head 212 that is knurled to facilitate turning with fingers.

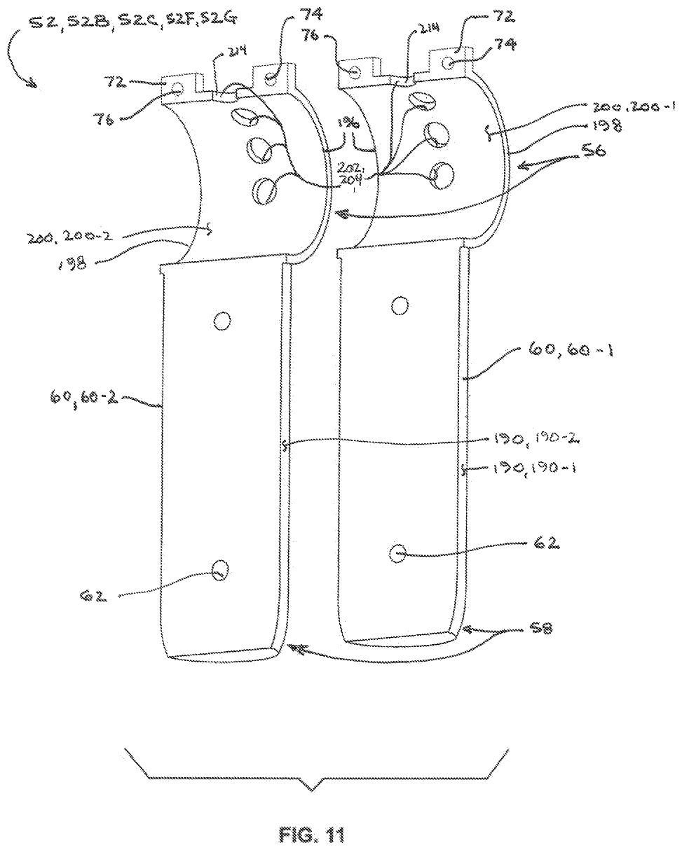

In coupling mechanism 180B, the plurality of first voids 202 is located in cylindrical outer bearing surface 186 of handle first portion 44B, and through the cylindrical wall of third end 56 of handle second portion 52B, which is separately shown in FIGS. 10 and 11.

In coupling mechanism 180B, the plurality of second voids 204 included amongst first voids 202 comprises seven (7) through holes 204 located in an imaginary plane that is normal to first axis 46. As depicted, this imaginary plane contains second axis 54 and is axially located centrally between shoulders 192, 194. Through holes 204 extend radially through the cylindrical wall of third end 56 toward first axis 46 and are angularly spaced at 30° intervals thereabout. The circumferentially centermost of through holes 204 is located between flanges 72 at third end 56 of handle second portion 52B, along the joint between second portion halves 60-1 and 60-2, as best seen in FIGS. 10 and 11. As shown, second portion halves 60-1 and 60-2 are provided with semicircular voids in their mutually abutting edges between flanges 72 that, when the halves are mated, form a circular through hole 204 that is receivable of set screw 210.

In coupling mechanism 180B, third void 206 included amongst first voids 202 is a singular threaded hole 206, or retention void 208-1, located in the above-mentioned imaginary plane that is normal to first axis 46, and which extends radially toward first axis 46. To engage coupling mechanism 180B, threaded hole 206 and a desired one of through holes 204 are radially aligned to establish the pair of retention voids 208, and setscrew 210 is received therein to mutually retain handle first and second portions 44B, 52B in the desired radial orientation. Set screw 210 is removed to disengage coupling mechanism 180B.

As shown in FIGS. 9 to 11, 18 and 25, the coupling mechanism 180F, 180G and handle second portion 52F, 52G of fishing pole assembly 40F, 40G, and handle 42F, 42G are substantially identical to coupling mechanism 180B and handle second portion 52B of fishing pole assembly 40B and handle 42B, described above. Therefore, it is to be understood that the above description, as it relates to coupling mechanism 180B and handle second portion 52B, applies equally to coupling mechanisms 180F, 180G and handle second portions 52F, 52G of fishing pole assembly embodiments 40F and 40G, and handles 42F and 42G thereof.

Coupling mechanism 180C of handle 42C and fishing pole assembly 40C, which selectively engages handle first and second portions 44C and 52C thereof, is depicted in FIG. 12. In coupling mechanism 180C, retention member 210 is pin 210 shown in FIG. 13. Pin 210 has integrally formed domed head 216 that facilitates its ready entry, under the biasing force of compression spring 218, into engagement with one of the pair of retention voids 208, and exit from and disengagement with one of the pair of retention voids 208 when head 216 is depressed against the biasing force of compression spring 218, as described further below. Pin 210 integrally includes elongate, cylindrical portion 220 that extends along central pin axis 222 between domed head 216 and one axial end of concentric, right cylindrical flange 224 that forms a base against which compression spring 218 bears.

In coupling mechanism 180C, the plurality of first voids 202 is located in cylindrical outer bearing surface 186 of handle first portion 44C, and through the cylindrical wall of third end 56 of handle second portion 52C, which is separately shown in FIGS. 10 and 11.

In coupling mechanism 180C, the plurality of second voids 204 included amongst first voids 202 comprises seven (7) through holes 204 located in an imaginary plane that is normal to first axis 46. As depicted, this imaginary plane contains second axis 54 and is axially located centrally between shoulders 192, 194. Through holes 204 extend radially through the cylindrical wall of third end 56 toward first axis 46 and are angularly spaced at 30° intervals thereabout. The circumferentially centermost of through holes 204 is located between flanges 72 at third end 56 of handle second portion 52C, along the joint between second portion halves 60-1 and 60-2, as best seen in FIGS. 10 and 11. As shown, second portion halves 60-1 and 60-2 are provided with semicircular voids in their mutually abutting edges between flanges 72 that, when the halves are mated, form a circular through hole 204 that, like each of the other second voids 204, is receivable of elongate cylindrical portion 220 of pin 210. In certain embodiments of handle second portion 52C, the intersection of each through hole 204 and cylindrical inner bearing surface 200 is chamfered.

In coupling mechanism 180C, third void 206 included amongst first voids 202 is a singular, cylindrical blind hole 206, or retention void 208-1, located in the above-mentioned imaginary plane that is normal to first axis 46, and which extends radially toward first axis 46. Blind hole 206 has a depth sufficient to receive the entirety of pin 210 and spring 218 as maximally compressed therein. Blind hole 206 has a diameter that is larger than the diameter of through holes 204, and slidably engages the circumferences of cylindrical flange 224 of pin 210 and spring 218. To engage coupling mechanism 180C, blind hole 206 and a desired one of through holes 204 are radially aligned to establish the pair of retention voids 208, and domed head 216 and elongate cylindrical portion 220 of pin 210 are urged by spring 218 into and through hole 204 (i.e., retention void 208-2), with head 216 disposed radially outside of cylindrical third surface segment 188. Flange 224 of pin 210 is too large in diameter to be received into retention void 208-2, and remains within blind hole 206 (i.e., retention void 208-1), with the radially-outward facing annular shoulder of cylindrical flange 224 abutting cylindrical inner bearing surface 200, thus mutually retaining handle first and second portions 44C, 52C in the desired radial orientation.

Sufficiently depressing pin 210 toward first axis 46, against the biasing force of compression spring 218, to position the apex of domed head 216 at or radially within cylindrical third surface segment 188 while applying torque about first axis 46 between handle first and second portions 44C, 52C, will slidably induce further radially inward movement of pin 210 and disengagement of coupling mechanism 180C, the ease of which can be enhanced where each respective retention void 208-2 is chamfered as mentioned above to better facilitate sliding movement between domed head 216 of depressed pin 210 and third end 56 of handle second portion 52C. Pin 210 remains captured in retention void 208-1 when coupling mechanism 180C is either engaged or disengaged.

The respective coupling mechanism 180F or 180G of fishing pole assembly 40F or 40G and/or handle 42F or 42G may be similarly configured to include the structure, componentry and/or methods described above regarding coupling mechanism 180C of fishing pole assembly 40C and/or handle 42C.

Coupling mechanism 180D of handle 42D and fishing pole assembly 40D, which selectively engages handle first and second portions 44D and 52D thereof, is depicted in FIG. 14. In coupling mechanism 180D, retention member 210 is sphere 210. Compression spring 218 bears against sphere 210, biasing sphere 210 radially outward relative to first axis 46.

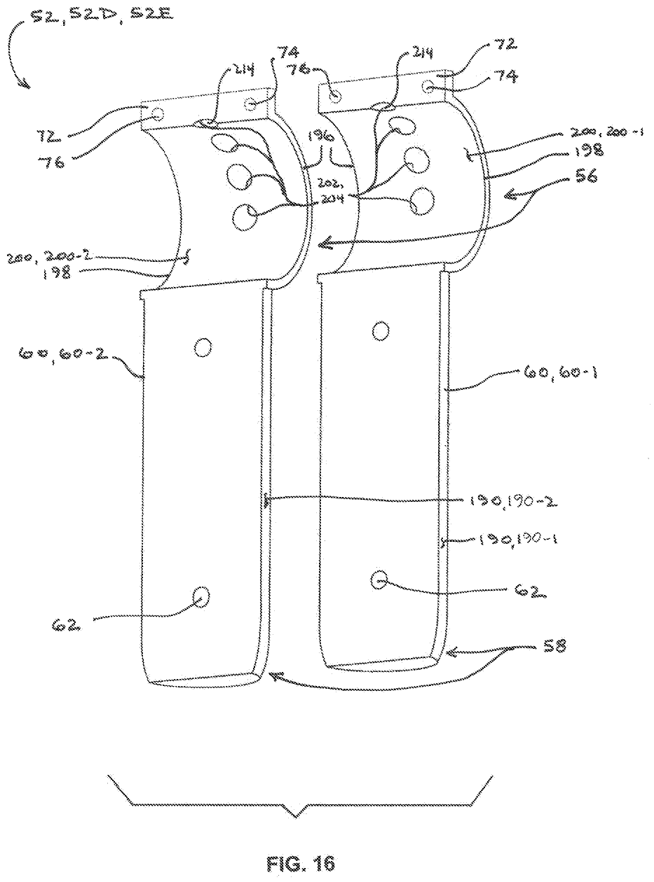

In coupling mechanism 180D, the plurality of first voids 202 is located in cylindrical outer bearing surface 186 of handle first portion 44D, and in cylindrical inner bearing surface 200 of third end 56 of handle second portion 52D, which is separately shown in FIGS. 15 and 16.

In coupling mechanism 180D, the plurality of second voids 204 included amongst first voids 202 comprises seven (7) hemispherical cavities located in an imaginary plane that is normal to first axis 46. As depicted, this imaginary plane contains second axis 54 and is axially located centrally between shoulders 192, 194. Hemispherical cavities 204 are angularly spaced at 30° intervals about first axis 46. The circumferentially centermost of hemispherical cavities 204 is located between flanges 72 at third end 56 of handle second portion 52D, along the joint between second portion halves 60-1 and 60-2, as best seen in FIGS. 15 and 16. As shown, second portion halves 60-1 and 60-2 are provided with semi-hemispherical voids in their mutually abutting edges between flanges 72 that, when the halves are mated, form a hemispherical cavity 204 that, like each of the other second voids 204, is receivable of half, or slightly less than half, of sphere 210.

In coupling mechanism 180D, third void 206 included amongst first voids 202 is a singular, cylindrical blind hole 206, or retention void 208-1, located in the above-mentioned imaginary plane that is normal to first axis 46, and which extends radially toward first axis 46. Blind hole 206 has a depth sufficient to receive the entirety of sphere 210 and spring 218 as maximally compressed therein. Blind hole 206 has a diameter that is approximately equivalent to the diameter of second voids 204, and slidably engages the circumferences of sphere 210 and spring 218. To engage coupling mechanism 180D, blind hole 206 and a desired one of hemispherical cavities 204 are radially aligned to establish the pair of retention voids 208, and a radially outward portion of sphere 210 is urged by spring 218 into a hemispherical cavity 204 (i.e., retention void 208-2). The radially inward portion of sphere 210 remains within blind hole 206 (i.e., retention void 208-1). Handle first and second portions 44D, 52D remain mutually retained in a selected radial orientation while torque applied about first axis 46 between handle first and second portions 44D, 52D remains below a breakaway level, which is contemplated to be in the range of approximately 6 Nm to approximately 12 Nm.

Applying a torque in excess of the breakaway torque level about first axis 46 between handle first and second portions 44D, 52D slidably induces radially inward movement of sphere 210 against the biasing force of spring 218 and out of retention void 208-2, disengaging coupling mechanism 180D. Sphere 210 remains captured in retention void 208-1 when coupling mechanism 180C is either engaged or disengaged.

The respective coupling mechanism 180F or 180G of fishing pole assembly 40F or 40G and/or handle 42F or 42G may be similarly configured to include the structure, componentry and/or methods described above regarding coupling mechanism 180D of fishing pole assembly 40D and/or handle 42D.

Coupling mechanism 180E of handle 42E and fishing pole assembly 40E, which selectively engages handle first and second portions 44E and 52E thereof, is depicted in FIG. 17. In coupling mechanism 180E, retention member 210 is elongate, right cylindrical pin 210′, one end of which is configured to provide a hemispherical head. Compression spring 218 bears against pin 210′, biasing pin 210′ radially outward relative to first axis 46.

In coupling mechanism 180E, the plurality of first voids 202 is located in cylindrical outer bearing surface 186 of handle first portion 44E, and in cylindrical inner bearing surface 200 of third end 56 of handle second portion 52E, which is separately shown in FIGS. 15 and 16.

In coupling mechanism 180E, the plurality of second voids 204 included amongst first voids 202 comprises seven (7) hemispherical cavities located in an imaginary plane that is normal to first axis 46. As depicted, this imaginary plane contains second axis 54 and is axially located centrally between shoulders 192, 194. Hemispherical cavities 204 are angularly spaced at 30° intervals about first axis 46. The circumferentially centermost of hemispherical cavities 204 is located between flanges 72 at third end 56 of handle second portion 52E, along the joint between second portion halves 60-1 and 60-2, as best seen in FIGS. 15 and 16. As shown, second portion halves 60-1 and 60-2 are provided with semi-hemispherical voids in their mutually abutting edges between flanges 72 that, when the halves are mated, form a hemispherical cavity 204 that, like each of the other second voids 204, is receivable of the hemispherical head of pin 210′.

In coupling mechanism 180E, third void 206 included amongst first voids 202 is a singular, cylindrical blind hole 206, or retention void 208-1, located in the above-mentioned imaginary plane that is normal to first axis 46, and which extends radially toward first axis 46. Blind hole 206 has a depth sufficient to receive the entirety of pin 210′ and spring 218 as maximally compressed therein. Blind hole 206 has a diameter that is approximately equivalent to the diameter of second voids 204, and slidably engages the circumferences of pin 210′ and spring 218. To engage coupling mechanism 180E, blind hole 206 and a desired one of hemispherical cavities 204 are radially aligned to establish the pair of retention voids 208, and the hemispherical head of pin 210′ is urged by spring 218 into a hemispherical cavity 204 (i.e., retention void 208-2). The cylindrical portion of pin 210′ remains within blind hole 206 (i.e., retention void 208-1). Handle first and second portions 44E, 52E remain mutually retained in a selected radial orientation while torque applied about first axis 46 between handle first and second portions 44E, 52E remains below a breakaway level, which is contemplated to be in the range of approximately 6 Nm to approximately 12 Nm.

Applying a torque in excess of the breakaway torque level about first axis 46 between handle first and second portions 44E, 52E slidably induces radially inward movement of pin 210′ against the biasing force of spring 218 and out of retention void 208-2, disengaging coupling mechanism 180E. Pin 210′ remains captured in retention void 208-1 when coupling mechanism 180C is either engaged or disengaged.

The respective coupling mechanism 180F or 180G of fishing pole assembly 40F or 40G and/or handle 42F or 42G may be similarly configured to include the structure, componentry and/or methods described above regarding coupling mechanism 180E of fishing pole assembly 40E and/or handle 42E.

While described herein with respect to particular embodiments, the present invention(s) can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A fishing pole handle, comprising:
an elongate first portion, said first portion having a first axis along which said first portion extends, said first portion having a first end and a second end, said first end and said second end spaced along said first axis, said first portion configured to engage a foot of a reel assembly attachable to said fishing pole handle at a reel assembly attachment position that has a radially fixed orientation about said first axis and an axially fixed location in directions along said first axis;
an elongate second portion, said second portion having a second axis along which said second portion extends, said second portion having a third end and a fourth end, said third end and said fourth end spaced along said second axis, said third end rotatably connected to said first portion about said first axis, said second axis substantially perpendicular to said first axis, said second portion spaced from said first end and said second end; and
a selectively engageable coupling mechanism between said first portion and said second portion, said first portion and said second portion rotatably retainable to each other about said first axis through engagement of said coupling mechanism, said first portion and said second portion relatively moveable about said first axis through disengagement of said coupling mechanism;
wherein said first portion and said second portion are constrained against relative movement in directions along said first axis; and
wherein, relative to each other about said first axis, said first portion and said second portion are selectively moveable between alternative ones of a plurality of different radial orientations or rotatably retained to each other in one of said plurality of different radial orientations.

2. The fishing pole handle of claim 1, wherein in directions along said first axis said reel assembly attachment position is located between said second portion and said second end.

3. The fishing pole handle of claim 1, wherein said first portion has an outer surface extending along and about said first axis, and said outer surface is configured to engage the foot of a reel assembly attachable to said fishing pole handle at said reel assembly attachment position.

4. The fishing pole handle of claim 3, wherein said first portion is configured for attachment of a reel assembly to said outer surface with bindings that extend over the reel assembly foot and about said first axis, whereby movement of a reel assembly when attached to said reel assembly attachment position is retained against movement toward said first end and about said first axis.

5. The fishing pole handle of claim 3, wherein said outer surface is provided with a pocket configured to be receivable of a rearward end of the foot of a reel assembly attachable to said fishing pole handle, whereby movement of a reel assembly when attached to said reel assembly attachment position is retained against movement toward said first end and about said first axis.

6. The fishing pole handle of claim 5, wherein said pocket is a first pocket, and further comprising a third portion, said third portion configured to surround said outer surface at a location along said first axis between said first pocket and said second end, said third portion defining a second pocket configured to be receivable of a forward end of the foot of the attachable reel assembly.

7. The fishing pole handle of claim 6, further comprising a fourth portion, said fourth portion configured to surround and securably engage said first portion, said fourth portion abuttingly engageable with said third portion, whereby movement of said third portion toward said second end along said first axis is constrained by abutment between said third portion and said fourth portion and movement of said third portion away from said second end along said first axis is constrained by the forward end of the foot of an attached reel assembly.

8. The fishing pole handle of claim 7, wherein said first portion and said fourth portion are provided with cooperating threads and are securably engageable by being threadedly interconnected.

9. The fishing pole handle of claim 6, wherein said first portion and said third portion are provided with cooperating interlocking features and are securably engageable by said features being cooperatively interlocked.

10. The fishing pole handle of claim 9, wherein said third portion has a central axis about which said third portion extends; and
wherein said third portion and said first portion are configured to permit relative sliding movement therebetween in both directions along said first axis when said central axis and said first axis are substantially parallel, and to prevent relative sliding movement therebetween in one direction along said first axis when said central axis and said first axis are substantially nonparallel.

11. The fishing pole handle of claim 1, wherein said third end extends about said first portion and surrounds said first axis.

12. The fishing pole handle of claim 11, wherein said second portion comprises separable parts cooperatively interconnected to retain said third end in surrounding disposition about said first axis.

13. The fishing pole handle of claim 11, wherein said first portion has an outer surface extending along and about said first axis, and said outer surface has a pair of substantially cylindrical first and second surface segments, said first and second surface segments spaced along said first axis;
wherein said third end has a substantially cylindrical third surface segment disposed axially between said pair of first and second surface segments; and
wherein said substantially cylindrical first, second and third surface segments are substantially located at a common radial distance from said first axis.

14. The fishing pole handle of claim 13, wherein said second portion extends in a direction along said second axis between said substantially cylindrical third surface segment and said fourth end.

15. The fishing pole handle of claim 13, wherein said second portion has an outer surface extending along and about said second axis between said substantially cylindrical third surface segment and said fourth end.

16. The fishing pole handle of claim 11, wherein said first portion has an axially interfacing pair of annular shoulders spaced in directions along said first axis, and said third end is disposed along said first axis between said axially interfacing pair of annular shoulders; and
wherein relative movement between said first portion and said second portion in directions along said first axis is constrained by abutting engagement between said third end and said axially interfacing pair of annular shoulders.

17. The fishing pole handle of claim 11, wherein said plurality of different radial orientations is a plurality of discrete radial orientations, and said first portion and said second portion are rotatably retained to each other in each of said plurality of discrete radial orientations through the engagement of said coupling mechanism.

18. The fishing pole handle of claim 17, wherein said coupling mechanism comprises:
a plurality of first voids in both said first portion and in said second portion, each one of said plurality of first voids extending radially relative to said first axis, wherein said plurality of first voids includes a plurality of second voids in either one of said first portion or said second portion and a third void in the other one of said first portion or said second portion, and wherein, in each of said plurality of discrete radial orientations, a respective one of said plurality of second voids and said third void are a pair of retention voids, each pair of retention voids in said first portion and in said second portion and radially aligned about said first axis; and
a retention member disposed in said pair of retention voids during engagement of said coupling mechanism, said first portion and said second portion rotatably retained in one of said plurality of discrete radial orientations through the engagement of said retention member with said pair of retention voids.

19. The fishing pole handle of claim 18, wherein said retention member is a set screw, and said pair of retention voids is a pair of holes receivable of said set screw.

20. The fishing pole handle of claim 18, wherein said retention member is captured in a said retention void in said first portion, is moveable in substantially radial directions relative to said first axis, and is biased in a substantially radial direction away from said first axis; and
wherein said retention member is received into engagement with a respective said retention void in said second portion during engagement of said coupling mechanism.

21. The fishing pole handle of claim 20, wherein said retention member is elongate and longitudinally parallel with the substantially radial directions in which said retention member is moveable.

22. The fishing pole handle of claim 21, wherein the retention void in said second portion is a through hole through which said retention member is receivable.

23. The fishing pole handle of claim 20, wherein the retention void in said second portion is a cavity that is open in a radially inward direction relative to said first axis.

24. The fishing pole handle of claim 20, wherein said retention member is substantially spherical.

25. The fishing pole handle of claim 1, wherein, relative to each other about said first axis, said first portion and said second portion have a plurality of discrete radial orientations;
wherein, in each one of said plurality of discrete radial orientations, said first portion and said second portion are rotatably retained to each other about said first axis within a range of retention torque levels therebetween that is less than a respective breakaway torque level; and
wherein said first portion and said second portion are selectively relatively moveable about said first axis from one of said plurality of discrete radial orientations and toward another of said plurality of discrete radial orientations in response to being selectively urged about said first axis by an applied torque therebetween that exceeds the respective breakaway torque level.

26. The fishing pole handle of claim 1, wherein a bore is provided in said first portion, said bore extending from a bore opening in said second end in a rearward direction that is generally along said first axis, said bore receivable of a rod member.

27. A fishing pole assembly comprising the fishing pole handle of claim 26 and said rod member, said rod member having and extending between a rod member rear end and a rod member front end, said rod member having a first longitudinal segment terminating at said rod member rear end and a second longitudinal segment terminating at said rod member front end, said rod member first longitudinal segment disposed in said bore and affixed to said first portion, said rod member projecting from said second end of said first portion in a forward direction that is generally along said first axis.

28. The fishing pole assembly of claim 27, further comprising a plurality of guides affixed to said rod member at locations spaced along said rod member second longitudinal segment.

29. The fishing pole assembly of claim 28, comprising a reel assembly, said reel assembly having a foot attached to said fishing pole handle at said reel assembly attachment position.

30. A fishing pole assembly comprising the fishing pole handle of claim 1 and a reel assembly having a foot attached to said fishing pole handle at said reel assembly attachment position.
